(19) United States
(12) Patent Application Publication
(10) Pub. No.: US 2020/0311357 A1
(43) Pub. Date: Oct. 1, 2020

(54) AUTHENTICATION PROCESSING SYSTEM, AUTHENTICATION METHOD AND IMAGE PROCESSING APPARATUS

(71) Applicant: Oki Data Corporation, Tokyo (JP)

(72) Inventors: Rowel del Rosario, Tokyo (JP); Takafumi FUKUDA, Tokyo (JP); Toshio TOUNE, Tokyo (JP)

(21) Appl. No.: 16/791,115

(22) Filed: Feb. 14, 2020

(30) Foreign Application Priority Data
Mar. 27, 2019 (JP) 2019-060431

(51) Int. Cl. G06K 7/10; G06F 7/58

(52) U.S. Cl. CPC G06K 7/10297; G06F 7/588

(57) ABSTRACT

An authentication method includes steps in which an information processing apparatus acquires user information, writes first identification information to an NFC tag, the mobile terminal acquires the first identification information via NFC and stores the acquired first identification information, after the mobile terminal acquired the first identification information, the information processing apparatus stores the first identification information and sets a validity time period, the mobile terminal transmits authentication request information corresponding to authentication information and the acquired information to the information processing apparatus via long distance wireless communication, the information processing apparatus determines whether or not the authentication request information is received before the validity time period has passed, and when the authentication request information is received from the mobile terminal within the validity time period, the information processing apparatus performs an authentication process based on the user information, the first identification information, and the authentication request information.

### TECHNICAL FIELD

The present invention relates to an authentication processing system, an authentication method and an information processing apparatus.

### BACKGROUND

Conventionally, for performing authentication with a multifunction machine using a mobile terminal, there is a method in which authentication is performed by using a mobile terminal to write authentication information to an NFC (near field communication) tag of a multifunction machine.

### RELATED ART

[Patent Doc. 1] JP Laid-Open Patent Application Publication 2016-21654

However, in the conventional method, for a mobile terminal that cannot write authentication information or the like to an NFC tag, authentication cannot be performed using an NFC tag.

The present invention is accomplished in view of the above problem, and is intended to provide an authentication method using an NFC tag and a mobile terminal even though the mobile terminal cannot write authentication information to an NFC tag.

### SUMMARY

An authentication method, disclosed in the application, includes a step in which an information processing apparatus acquires user information; a step in which the information processing apparatus writes first identification information to an NFC tag; a step in which the mobile terminal acquires, via Near Field Communication (hereinafter as NFC), the first identification information written to the NFC tag and stores the acquired first identification information as acquired information; a step in which, after the mobile terminal acquired the first identification information, the information processing apparatus stores the first identification information and sets a validity time period for the first identification information; a step in which the mobile terminal transmits authentication request information corresponding to authentication information and the acquired information to the information processing apparatus via long distance wireless communication which is different from the NFC, a step in which the information processing apparatus determines whether or not the authentication request information is received from the mobile terminal before the validity time period of the first identification information has passed; and a step in which, when the authentication request information is received from the mobile terminal within the validity time period, the information processing apparatus performs an authentication process based on the user information, the first identification information, and the authentication request information.

In this application, the NFC stands for Near Field Communication. The NFC is a set of communication protocols that enable two electronic devices to establish communication by bringing them within 4 cm (One and a half inches) of each other. The NFC tag means a wireless communication tag designed for NFC. One type of NFC may be standardized in ECMA-340 and ISO/IEC 18092, or ISO/IEC 21481 and ECMA-352. Any other protocols and regulations, which has been organized or to be organized by GSM association, may be adopted to the invention.

The long distance wireless communication is realized, for example, by using Wi-Fi (Trademark of Wi-Fi Alliance) or Bluetooth (managed by Bluetooth Special Interest Group). Bluetooth is standardized as 802.15.1 of IEEE as of this application filed.

In this invention, the long distance wireless communication must be able to exchange data over a distance that is longer than the range of the near field communication. When NFC is used for the near field communication, Wi-Fi and

Bluetooth belong to the long field communication because of their longer communication ranges than NFC. Any other wireless communication of which a communication range is longer than that of NFC may be available for the long distance wireless communication of the invention.

According to the above configuration, authentication using an NFC tag can be performed even for a mobile terminal that cannot write to an NFC tag.

### BRIEF DESCRIPTION OF THE DRAWINGS

FIG. 1 illustrates a configuration of an information processing system in a first embodiment.

FIG. 2 illustrates a configuration of a multifunction machine in the first embodiment.

FIG. 3 illustrates a configuration of a mobile terminal in the first embodiment.

FIG. 4 illustrates a configuration of a dedicated application in the first embodiment.

FIGS. 5A-5C are schematic diagrams of information written to an NFC tag in the first embodiment.

FIG. 6 is a schematic diagram of random number information stored in the multifunction machine in the first embodiment.

FIG. 7 is a schematic diagram illustrating a configuration of authentication information in the first embodiment.

FIGS. 8A-8F illustrate screens of the mobile terminal in the first embodiment.

FIG. 9 is a flow diagram illustrating a flow until the mobile terminal in the first embodiment is held over the NFC tag.

FIG. 10 is a flow diagram illustrating an overall flow of an authentication process in the first embodiment.

FIG. 11 is a flow diagram illustrating an operation of the multifunction machine in the first embodiment.

FIG. 12 is a flow diagram illustrating an operation of the mobile terminal in the first embodiment.

FIG. 13 illustrates a configuration of a multifunction machine in a second embodiment.

FIG. 14 illustrates a configuration of a mobile terminal in the second embodiment.

FIG. 15 is a flow diagram illustrating an operation of the mobile terminal in the second embodiment.

FIG. 16 is a flow diagram illustrating an operation of the multifunction machine in the second embodiment.

FIG. 17 is a flow diagram after a login process in the second embodiment.

FIG. 18 illustrates a logout notification screen in the second embodiment.

FIG. 19 illustrates authentication information of a third embodiment.

FIGS. 20A and 20B are each a schematic diagram illustrating terminal information in a state in which random number information and an authentication information terminal ID stored in a multifunction machine in the third embodiment are associated with each other.

FIG. 21 is a flow diagram illustrating an operation of the multifunction machine in the third embodiment.

### DETAILED DESCRIPTION OF PREFERRED EMBODIMENTS

### First Embodiment

FIG. 1 illustrates a configuration of an authentication processing system in a first embodiment.

An information processing system includes a multifunction machine 100 and a mobile terminal 200. The multifunction machine 100 has an NFC tag 101 and a wireless network IF 14. The mobile terminal 200 has an NFC communication part 201 and a wireless network IF 202. Further, the multifunction machine 100 and the mobile terminal 200 are connected to each other as a communication system by the NFC tag 101 and the NFC communication part 201 such that communication therebetween via near field communication 300 (NFC) is possible. Herein, the NFC is one type of wireless communications. Further, the multifunction machine 100 and the mobile terminal 200 are connected to each other by the wireless network IF 14 and the wireless network IF 202 such that wireless communication therebetween is possible.

The multifunction machine 100 as an information processing apparatus in the present embodiment is a so-called multifunction peripheral (MFP) having functions such as printing, copying, scanning, and faxing. The multifunction machine 100 performs an authentication process based on user information registered in advance. After the authentication process, various processes are executed according to user instructions. For example, a function for performing printing based on print data transmitted from an external device such as a mobile terminal or transmission of scan data to a mobile terminal is performed.

The mobile terminal 200 as a mobile terminal of the present embodiment has functions such as that of a mobile phone, that of a camera, transmission and reception of emails, and web page browsing. For example, the mobile terminal 200 is a portable communication terminal such as a smartphone or a tablet. Further, the mobile terminal 200 can use an application tool or the like to transmit an authentication request, authentication information, or print data after authentication to the multifunction machine 100 via Wi-Fi (registered trademark) wireless communication 400 in order to use various functions of the multifunction machine 100.

When the mobile terminal 200 is held over the NFC tag 101, information on the NFC tag 101 of the multifunction machine 100 (to be described later) can be read by the mobile terminal 200 via the near field communication 300.

In the present embodiment, the Wi-Fi (registered trademark) wireless communication 400 is communication using a wireless LAN such as Wi-Fi (registered trademark). Further, the multifunction machine 100 itself performs the Wi-Fi (registered trademark) wireless communication 400 directly with the mobile terminal 200. On the other hand, it is also possible that the Wi-Fi (registered trademark) wireless communication 400 is performed via an external wireless LAN access point. Further, in general, when the Wi-Fi (registered trademark) wireless communication 400 is directly performed between the multifunction machine 100 and the mobile terminal 200, a wireless communication area is an area of a distance of about 1-5 m from the multifunction machine, and a wireless communication area via an external access point is an area of a distance of 20-30 m from the multifunction machine 100.

Here, the near field communication 300 corresponds to a specific example of near field communication in the present invention, and the Wi-Fi (registered trademark) wireless communication 400 corresponds to long distance wireless communication in the present invention.

The NFC tag 101 holds device information 106 such as an identifier for connecting to a device in order to perform the Wi-Fi (registered trademark) wireless communication 400 (to be described later) and random number information 105 as identification information for identifying the mobile terminal 200. Further, by holding the mobile terminal 200 over the NFC tag 101 to a distance of about 0 cm-5 cm, as described above, communication between the multifunction machine 100 and the mobile terminal 200 is performed via the near field communication 300, and thus, is less likely to be intercepted by others than communication via the Wi-Fi (registered trademark) wireless communication 400.

A touch panel 210 is an input and output device that displays various kinds of information and receives an input operation from a user.

An operation panel 110 is an input and output device for displaying a device state and for receiving an input instruction from a user. In the present invention, it is also possible that the operation panel 110 is not included.

As described above, by physically bringing the mobile terminal 200 close to the multifunction machine 100 as a communication target, the NFC communication part 201 reads the random number information 105 and the device information 106 from the NFC tag 101.

Next, configurations of the multifunction machine 100 and the mobile terminal 200 in the present embodiment are briefly described.

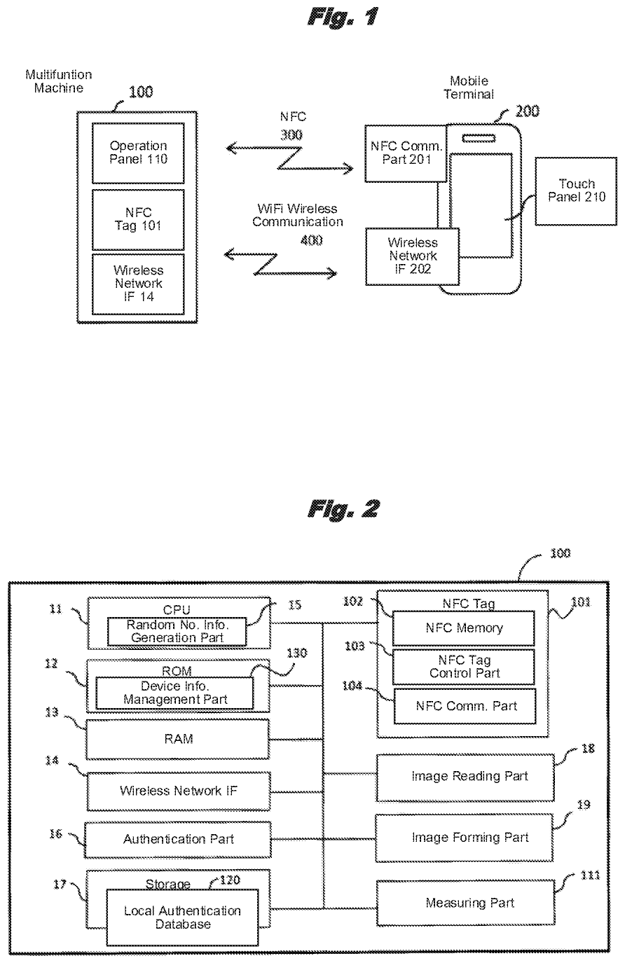

FIG. 2 illustrates the configuration of the multifunction machine 100 of the present invention in the present embodiment.

A CPU 11 (Central Processing Unit) is a processor that performs various arithmetic operations and controls the entire multifunction machine 100 such as execution of programs. The CPU 11 controls operations of blocks in the multifunction machine 100 by executing various programs. Further, the CPU 11 stores the random number information 105 read by the mobile terminal 200 in a RAM 13 (to be described later), and sets a validity time period. Further, the CPU 11 has a random number information generation part 15 for generating a random number, and generates the random number information 105.

Further, the CPU 11 corresponds to a specific example of a first control part in the present invention.

A ROM 12 is a non-volatile storage device that stores programs for device control, communication control, and the like. Further, the ROM 12 has a device information management part 130. The device information management part 130 manages the device information 106 for identifying a device in order to perform the Wi-Fi (registered trademark) wireless communication 400 with the mobile terminal 200.

The RAM 13 is a volatile storage device that stores a work area used by the CPU 11 during execution of various programs. In the present embodiment, the RAM 13 temporarily stores the random number information 105 read by the mobile terminal 200. The RAM 13 corresponds to a specific example of an identification information storage part in the present invention.

The wireless network IF 14 connects to a network and controls communication when the Wi-Fi (registered trademark) wireless communication 400 is performed with the mobile terminal 200. Further, the wireless network IF 14 performs the Wi-Fi (registered trademark) wireless communication 400 with the mobile terminal 200, and performs transmission and reception of various kinds of data and performs transmission and reception of an authentication request and/or an authentication result based on authentication information 203 (to be described later). Here, the various kinds of data include image data, a job list of authentication printing and the like transmitted from the mobile terminal 200.

The wireless network IF 14 corresponds to a specific example of a second wireless communication part in the present invention.

An authentication part 16 performs an authentication process of the mobile terminal 200 based on the user information and the authentication information 203. The authentication process will be described in detail later.

The NFC tag 101 is attached to the multifunction machine 100 for performing the near field communication 300 with the mobile terminal 200. Details will be described later. Next, a storage 17 is a non-volatile storage device including a hard disk or the like that stores various kinds of setting information or management information. The storage 17 has a local authentication database 120 (to be described later).

An image forming part 19 forms an image on a recording medium such as a sheet of paper, and, for example, forms an image using an electrophotographic method.

An image reading part 18 reads information printed on a reading medium such as a sheet of paper, and is configured using, for example, a contact image sensor (CIS).

A measuring part 111 measures a time period in the device. In the present embodiment, the measuring part 111 measures a time period of a set validity time period (such as 10 seconds or 20 seconds).

As illustrated in FIG. 2, an NFC memory 102 is a non-volatile memory in which the device information 106 and the random number information 105 for performing communication with the mobile terminal 200 such as the random number information 105 generated by the random number information generation part 15 and the device information 106 are written by an NFC tag control part 103, and the non-volatile memory is held on the NFC tag 101. Hereinafter, an operation with respect to the NFC tag control part 103 toward the NFC memory 102 is simply described as writing to the NFC tag 101.

The NFC tag control part 103 is controlled by the CPU 11. The NFC tag control part 103 performs various controls related to the NFC tag 101. Further, the random number information 105 and the device information 106 are written to the NFC memory 102 according to a command of the CPU 11. Further, when the multifunction machine 100 itself is used as an access point, wireless access point information (such as a service set identifier) for connection is also written to the NFC memory 102.

An NFC communication part 104 is configured to perform the near field communication 300 with the mobile terminal 200. The NFC communication part 104 corresponds to a specific example of a first wireless communication part in the present invention.

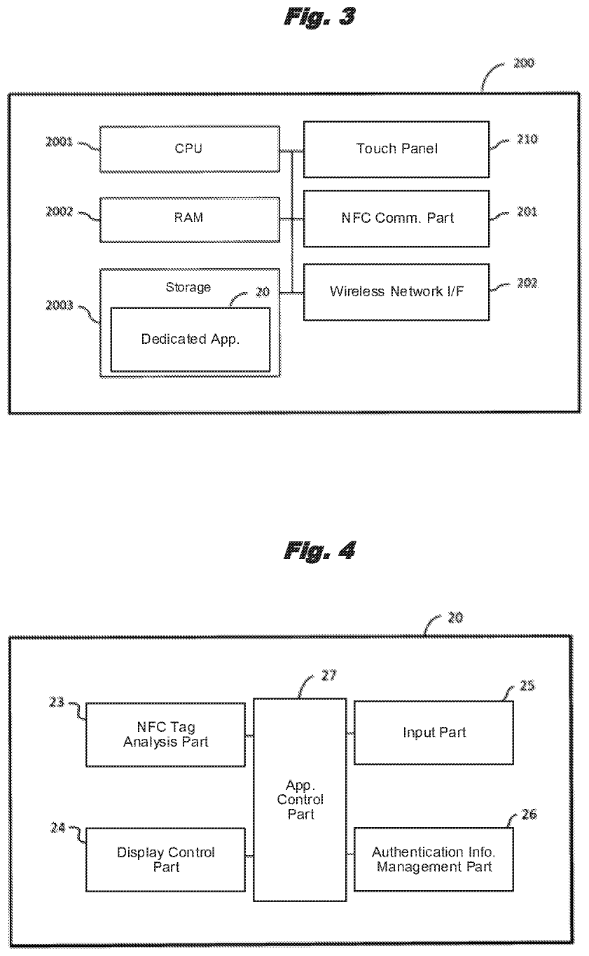

FIG. 3 illustrates a hardware configuration of the mobile terminal 200 in the present embodiment.

A CPU 2001 is a processor that performs various arithmetic operations and controls programs of the mobile terminal 200. A RAM 2002 is a volatile storage device that is for storing an area for storing various programs read from a storage 2003 (to be described later) and is for storing a work area for the CPU 2001 to execute the various programs. The storage 2003 is a non-volatile storage device for storing an operating system (OS), various control programs, and various application programs (such as a dedicated application 20).

The NFC communication part 201 communicates various kinds of information from the NFC tag 101 of the multifunction machine 100 according to an NFC standard. Further, the NFC communication part 201 performs the near field communication 300 between the multifunction machine 100 and the mobile terminal 200, and reads the random number information 105 and the device information 106 from the multifunction machine 100.

The wireless network IF 202 is connected to a wireless network in order to perform the Wi-Fi (registered trademark) wireless communication 400, and performs communication with the multifunction machine 100. The wireless network IF 202 performs the Wi-Fi (registered trademark) wireless communication 400 with the multifunction machine 100, and performs transmission and reception of various kinds of image data, a configuration change in output, an authentication result, and the like.

As described above, the touch panel 210 is an input and output device that displays various kinds of information and receives an input operation from a user. Further, the touch panel 210 is a display screen for displaying various kinds of information with respect to a user.

Further, the NFC communication part 201 corresponds to a specific example of a third wireless communication part in the present invention. The wireless network IF 202 corresponds to a specific example of a fourth wireless communication part in the present invention.

FIG. 4 illustrates a configuration of the dedicated application 20 in the present embodiment.

The dedicated application 20 is an application tool that is stored in the storage 2003 and performs various settings and services of the multifunction machine 100 from the mobile terminal 200. Further, the dedicated application 20 has an NFC tag analysis unit 23, a display control part 24, an input part 25, an authentication information management part 26, and an application control part 27.

The NFC tag analysis part 23 receives and analyzes information read from the NFC tag 101 by the NFC communication part 201, and acquires a content thereof. The display control part 24 displays a screen related to various settings, an authentication screen, and the like on the touch panel 210. The input part 25 as the input part of the present invention allows various kinds of information and settings to be input on the touch panel 210, and receives instructions.

The authentication information management part 26 manages settings and changes of authentication information input with the input part 25 in the authentication information 203. Further, the authentication information management part 26 stores the authentication information 203 that has been set or changed in the storage 2003.

The application control part 27 controls operations of the blocks in the dedicated application 20 by executing various programs. The application control part 27 is configured, for example, using the CPU 2001.

Further, the application control part 27 corresponds to a specific example of a second control part in the present invention.

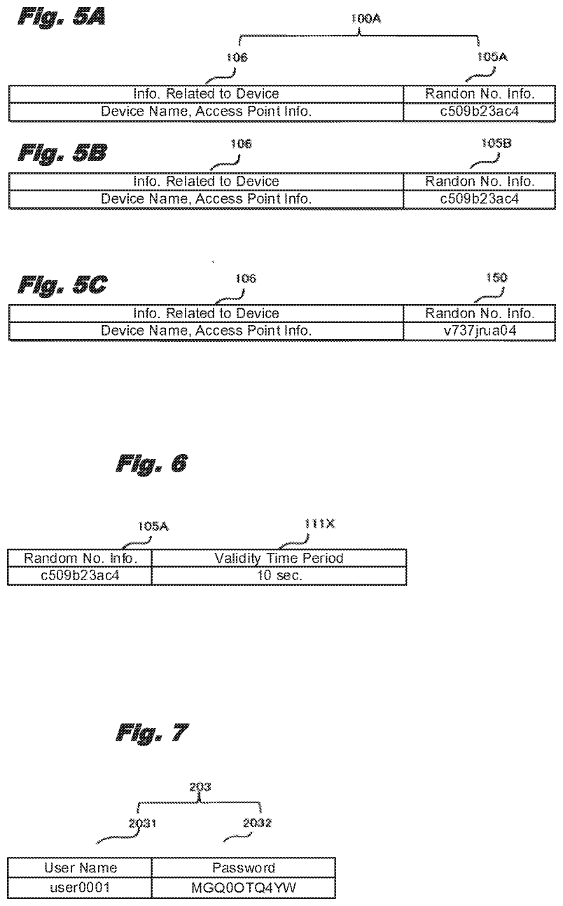

Next, the random number information 105 and the device information 106 are described using FIGS. 5A-5C and 6.

FIG. 5A is a schematic diagram of information written to the NFC tag 101 in the first embodiment. FIG. 5B is a schematic diagram of NFC tag information read by the mobile terminal 200 in the first embodiment. Random number information generated and managed in the multifunction machine 100 is denoted using “105A,” and random number information read by the mobile terminal 200 is denoted using “105B” (illustrated in FIG. 5B), and when a particular distinction between them is not necessary, they are referred to as the random number information 105. The random number information 105A corresponds to a specific example of first identification information in the present invention. Further, the random number information 105B corresponds to a specific example of acquired information in the present invention.

As described above, the device information 106 is managed by the device information management part 130, and is information related to a device, such as a device name or access point information, for identifying the device when an authentication process is performed. The access point information includes, for example, information about a service set identifier (SSID), a password, and the like. The random number information 105 is generated and managed by the random number information generation part 15 (CPU 11). Further, the random number information 105 is formed of randomly arranged alphanumeric characters and has a complicated configuration (such as c509b23ac4), and thus is excellent in confidentiality. When a particular distinction is not necessary, the above-described random number information 105A and device information 106 are collectively referred to as NFC tag information 100A.

Further, FIG. 5C is a schematic diagram illustrating random number information 150 in the present embodiment.

After the random number information 105A is read by the mobile terminal 200, the new random number information 150 (random number information different from the random number information 105) is generated by the random number information generation part 15, and the new random number information 150 and the device information 106 are information written to the NFC tag 101 by the NFC tag control part 103. The random number information 105 and the random number information 150 are temporarily used identification information used in an authentication process. Further, the new random number information 150 described above corresponds to a specific example of second identification information in the present invention.

FIG. 6 is a schematic diagram of the random number information 105A stored in the multifunction machine 100 in the present embodiment.

As illustrated in FIG. 6, after the random number information 105A is read by the mobile terminal 200, the CPU 11 sets a validity time period 111X and stores it in the RAM 13. Further, random number information 105A for which the validity time period 111X has passed becomes invalid identification information and is deleted from the RAM 13.

Here, the validity time period 111X may be allowed to be set and/or changed by a user as appropriate, or may be fixedly set in advance when firmware setting is performed (for example, at time of shipment from a factory). Further, the validity time period 111X is set to a time period from when the mobile terminal 200 reads the random number information 105 to when 10 seconds or 20 seconds has elapsed. The validity time period 111X is preferably as short a time period as possible. By setting the validity time period 111X, not only whether or not the random number information 105 transmitted from the mobile terminal 200 to the multifunction machine 100 via the Wi-Fi (registered trademark) wireless communication 400 is the random number information 105 read from multifunction machine 100 by the mobile terminal can be determined, but also that the user is in front of the multifunction machine 100 can be proved, and thus, an effect of improving security can be obtained.

Next, a configuration of the authentication information 203 is described.

FIG. 7 is a schematic diagram illustrating the configuration of the authentication information 203 in the present embodiment.

As illustrated in FIG. 7, the authentication information 203 mainly includes a user name 2031 and a password 2032.

The user name and the password are set and registered in advance by a user. Further, the user name 2031 is unique information indicating a user.

The password 2032 is a password for proving the user, and can be arbitrarily set and changed by the user.

The authentication information 203 is set and registered in advance as the user information by a user administrator of the multifunction machine 100 in order to authenticate from the mobile terminal 200 to the multifunction machine 100, and may be managed inside the multifunction machine 100 (in the storage 17), and it is also possible that an authentication server is externally provided using a lightweight directory access protocol (LDAP). In the present embodiment, a user name and a password are used as authentication information. However, it is also possible that terminal information of a mobile terminal is used as authentication information. Similarly, as the user information, terminal information may be registered in advance on the machine side. Here, the authentication information 203 input by a user and transmitted to the multifunction machine 100 corresponds to a specific example of authentication information of the present invention.

An authentication screen (application screen) of the mobile terminal 200 is described next.

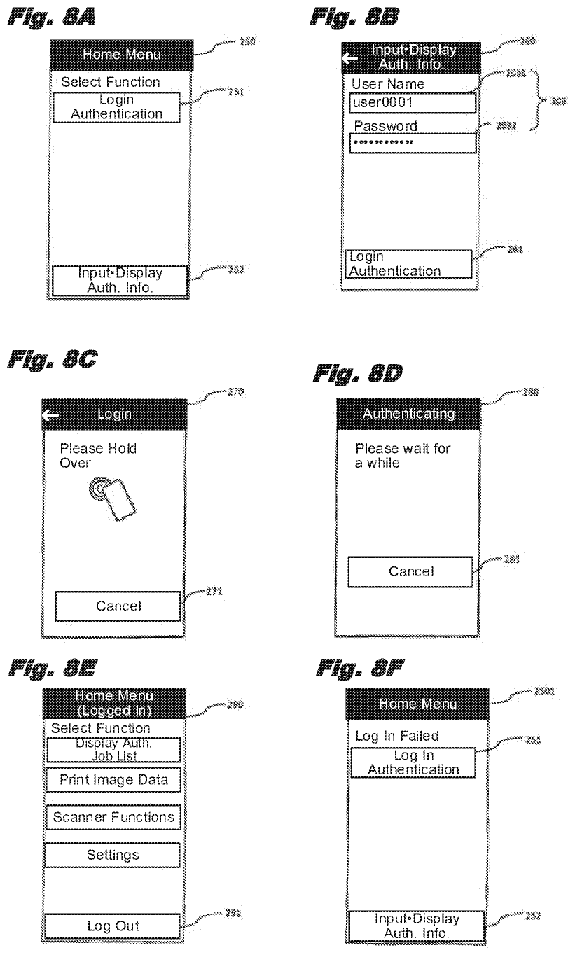

FIGS. 8A-8F each illustrate a display screen of the dedicated application 20 in the present invention.

FIG. 8A illustrates a home screen 250 of the dedicated application 20 in the present embodiment.

When a user starts the dedicated application 20 in order to perform authentication on the touch panel 210, the home screen 250 illustrated in FIG. 8A is displayed on the touch panel 210.

On the home screen 250, a login authentication button 251 for proceeding to login authentication and an authentication information button 252 for displaying the authentication information 203 are displayed.

FIG. 8B illustrates an authentication information input and display screen 260 in the present embodiment.

When the authentication information button 252 is pressed by a user, since the button 252 is pressed, the application control part 27 causes the display control part 24 to display the authentication information input and display screen 260 on the touch panel 210. When a user inputs authentication information 203 corresponding to user information on the authentication information input and display screen 260 and presses a login authentication button 261, an instruction screen 270 of FIG. 8C is displayed.

The input authentication information 203 is stored in the storage 2003 by the authentication information management part 26, and after that, it is also possible that the authentication information 203 is automatically displayed on the authentication information input and display screen 260. As a result, next, when login authentication is performed, it is only necessary to directly press the login authentication button 251 on the home screen 250 illustrated in FIG. 8A.

FIG. 8C illustrates the instruction screen 270 in the present embodiment.

In FIG. 8C, a screen (the instruction screen 270) prompting the user to hold the mobile terminal 200 over the NFC tag 101 is displayed. By holding the mobile terminal 200 over the NFC tag 101 while the screen is displayed, login authentication is executed by the authentication process (to be described later).

FIG. 8D illustrates an authenticating screen 280 in the present embodiment.

The authenticating screen 280 is a display screen of the touch panel 210 when an authentication request is transmitted from the mobile terminal 200 to the multifunction machine 100. Cancel buttons 271, 281 are respectively displayed on the screens of FIGS. 8C and 8D. Therefore, the user can cancel authentication by pressing the cancel buttons. When authentication is canceled, the display control part 24 displays the home menu 250 illustrated in FIG. 8A on the touch panel 210.

FIG. 8E illustrates a logged-in screen 290 in the present embodiment.

The logged-in screen 290 is a screen that is displayed when login authentication is successful. The logging-in screen 290 is a screen that displays various functions and settings in the multifunction machine 100. For example, there are displaying of an authentication job list, transmission and execution of image data, execution of a scan function, various device and application related settings, and the like. Further, by pressing a logout button 291, service of the dedicated application 20 related to the multifunction machine 100 can be terminated. The buttons on the display screens each form an input part 25.

FIG. 8F illustrates a home screen 2501 that is displayed as a login authentication result (failure) in the present embodiment. The home screen 2501 displays to the user that login has failed. The home screen 2501 displays a “Login failed” message. Further, similar to the home screen 2501, a login authentication button 251 for proceeding to login authentication again and an authentication information button 252 for displaying authentication information are displayed.

Next, an operation of the authentication process is described in detail.

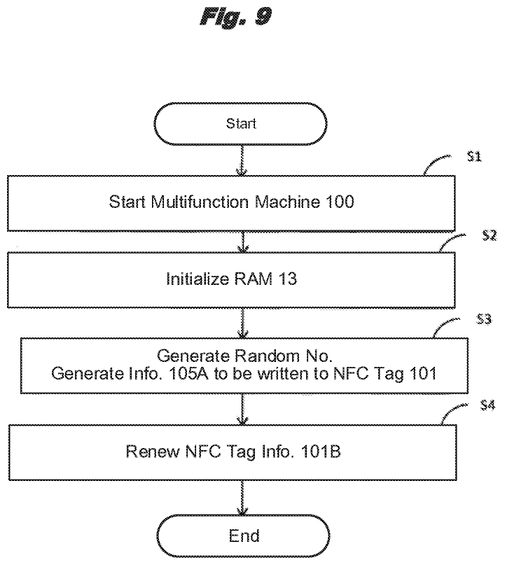

FIG. 9 is a flow diagram illustrating a flow until the mobile terminal 200 is held over the NFC tag 101 in the multifunction machine 100 in the present embodiment.

In S1, first, the multifunction machine 100 is started. In S2, the CPU 11 initializes the RAM 13. Specifically, the random number information 105A or the like held before the start of the device is cleared.

In S3, the random number information generation part 15 generates the random number information 105A. The CPU 11 changes the new random number information 105A and the device information 106 of the device information management part 130 to an appropriate format (for example, an NFC Data Exchange Format) for writing to the NFC tag 101.

In S4, the CPU 11 controls the NFC tag control part 103, and causes the NFC tag control part 103 to write the random number information 105A and device information 106 created in S3 to the NFC tag 101.

After the above steps, the multifunction machine 100 is in a standby state until the mobile terminal 100 is held over the NFC tag or until an authentication request is transmitted from the or mobile terminal 200.

Next, an overall operation of the authentication process in the first embodiment is briefly described.

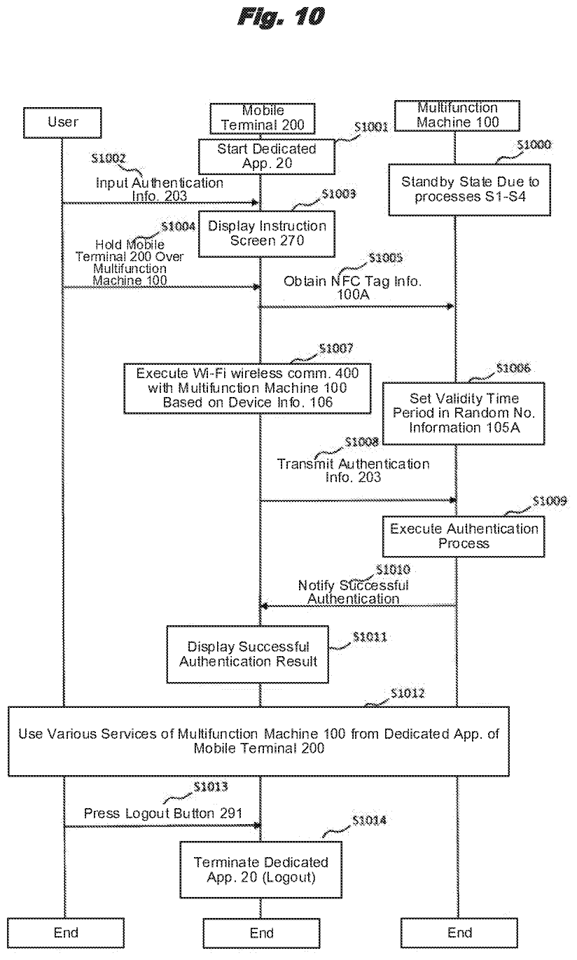

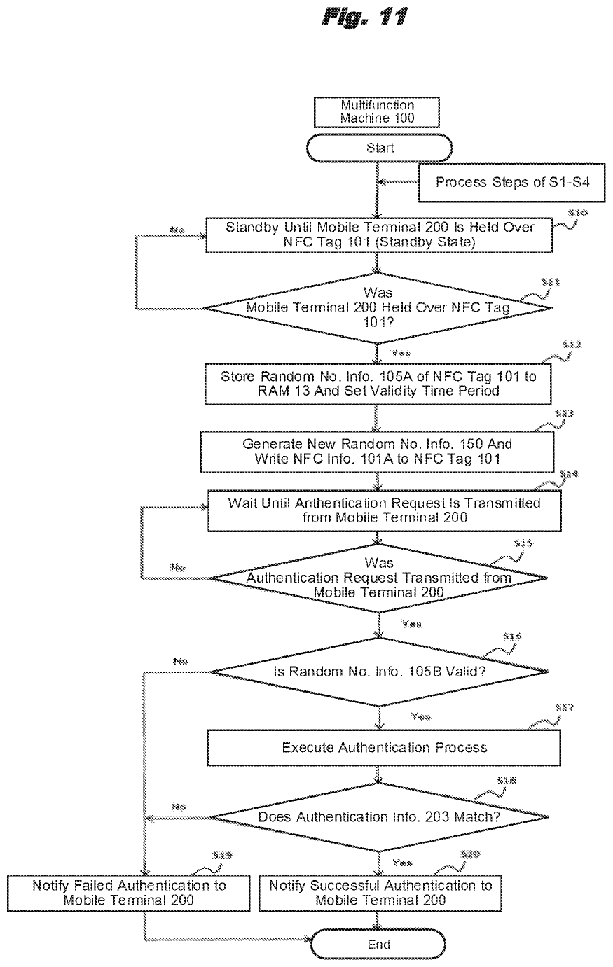

FIG. 10 is a flow diagram illustrating an overall flow of the authentication process in the present embodiment.

First, in S1000, the multifunction machine 100 is in the standby state described above waiting for the mobile terminal 200 to be held over the NFC tag. Here, the process up to the standby state is as described above, and thus is omitted.

In S1001, the user starts the dedicated application 20 stored in the storage 2003 of the mobile terminal 200 in order to perform authentication. Here, the mobile terminal 200 displays the home menu 250 described above on the touch panel 210.

In S1002, the user proceeds to the authentication information input and display screen 260, and inputs the authentication information 203 (the user name 2031 and the password 2032).

In S1003, the mobile terminal 200 displays the instruction screen 270 on the touch panel 210 and instructs the user to hold the mobile terminal 200 over the multifunction machine 100 (the NFC tag 101).

In S1004, the user holds the mobile terminal 200 over the multifunction machine 100 (the NFC tag 101), and then, in S1005, the mobile terminal 200 reads the NFC tag information 100A via the near field communication 300.

In S1006, the multifunction machine 100 stores the random number information 105A of the NFC tag information 100A read by the mobile terminal 200 in S1005, and sets the validity time period 111X.

In S1007, the mobile terminal 200 executes the Wi-Fi (registered trademark) wireless communication 400 with the multifunction machine 100 based on the device information 106 read in S1005.

In S1008, the mobile terminal 200 stores the read random number information 105B in the RAM 2002, and transmits the authentication information 203 input by the user in S1002 and the random number information 105B read in S1005 to the multifunction machine 100 via the Wi-Fi (registered trademark) wireless communication 400.

In S1009, the multifunction machine 100 executes an authentication process based on the authentication information 203 and the random number information 105B transmitted from the mobile terminal 200 in S1008.

In S1010, the multifunction machine 100 notifies the mobile terminal 200 via the Wi-Fi (registered trademark) wireless communication 400 that the authentication in S1009 is successful.

In S1011, the mobile terminal 200 displays the authentication result notified from the multifunction machine 100 in S1010 on the touch panel 210.

In S1012, the user can use various services of the multifunction machine 100 illustrated in FIG. 8E from the dedicated application 20 of the mobile terminal 200. In addition to the services illustrated in FIG. 8E, user-specific services such as function access restrictions may also be included.

In S1013 and S1014, when the user wants to terminate the use of the multifunction machine 100, the user can terminate the services of the multifunction machine 100 by pressing the logout button 291 displayed on the logged-in screen 290. Based on that the logout button 291 has been pressed in S1013, the mobile terminal 200 terminates (logs out) the dedicated application 20.

Next, an operation flow of the multifunction machine 100 in the authentication processing operation is described.

FIG. 11 is a flow diagram illustrating an operation of the multifunction machine 100 in the present embodiment. S10-S13 are steps describing the operation of the multifunction machine 100 in the operations of S1000-S1006 in FIG. 10.

In S10, the multifunction machine 100 is in a standby state until the mobile terminal 200 is held over the NFC tag 101. The details are as described above, and thus, are omitted here.

In S11, the multifunction machine 100 determines whether or not the mobile terminal 200 has been held over the NFC tag 101 and the mobile terminal 200 has read the NFC tag information 100A. When in S1005 the NFC tag information 100A of the NFC memory 102 is read by the mobile terminal 200 via the near field communication 300, the multifunction machine 100 determines that the mobile terminal 200 has been held over the NFC tag 101, and proceeds to S12.

Otherwise, the multifunction machine 100 returns to S10.

In S12, the NFC tag control part 103 acquires the NFC tag information 100A read by the mobile terminal 200 illustrated in FIG. 5A. As described above, the CPU 11 stores the random number information 105A of the NFC tag information 100A read by the NFC tag control part 103 in the RAM 13, and sets the validity time period 111X for the stored random number information 105A. In this case, the NFC tag information 100A on the NFC tag 101 is in an empty state. That is, the NFC tag control part 103 deletes the random number information 105A from the NFC tag 101 after the mobile terminal 200 reads the NFC tag information 100A (the random number information 105A).

In S13, the CPU 11 causes the random number information generation part 15 to generate new random number information 150, and causes the NFC tag control part 103 to write the generated new random number information 150 to the NFC tag 101. Specifically, the NFC tag control part 103 writes the new random number information 150 illustrated in FIG. 5C to the NFC tag 101. As a result, the random number information 150 different from the random number information 105 exists, and duplication in random number information can be prevented.

In S14, the multifunction machine 100 waits until an authentication request is transmitted from the mobile terminal 200 via the Wi-Fi (registered trademark) wireless communication 400. That is, the multifunction machine 100 waits until the authentication information 203 is transmitted from the mobile terminal 200 in S1008 of FIG. 10.

In S15, the multifunction machine 100 determines whether or not an authentication request has been transmitted via the Wi-Fi (registered trademark) wireless communication 400. Specifically, in S1008 illustrated in FIG. 10, whether or not the authentication information 203 has been transmitted from mobile terminal 200 is determined. When the wireless network IF 14 receives the authentication information 203 and the random number information 105B illustrated in FIG. 5A or FIG. 7, the CPU 11 determines that an authentication request has been transmitted from the mobile terminal 200, and proceeds to S16. Otherwise, in S14, the multifunction machine 100 waits until an authentication request is transmitted.

S16 and S17 are steps illustrating the processing of the multifunction machine 100 in S1009 illustrated in FIG. 10. In S16, the CPU 11 determines whether or not the random number information 105B in the authentication information 203 transmitted from the mobile terminal 200 is valid. Specifically, upon receiving the random number information 105 and the authentication information 203, the CPU 11 determines whether or not the random number information 105A stored in the RAM 13 has passed the validity time period 111X set in S12. When the CPU 11 determines that the validity time period 111X set for the random number information 105A stored in the RAM 13 has passed, the multifunction machine 100 determines that the random number information 105B is invalid random number information, and proceeds to S19 to notify the mobile terminal 200 via the wireless network IF 14 via the Wi-Fi (registered trademark) wireless communication 400 that the authentication has failed. In this case, the random number information 105A for which the validity time period 111X has passed is deleted from the RAM 13.

Next, when the CPU 11 determines that the validity time period 111X of the random number information 105A stored in the RAM 13 has not passed, that is, when the authentication information 203 is received from the mobile terminal 200 within a set time period (10 seconds), the CPU 11 determines whether or not the random number information 105B in the authentication information 203 matches the random number information 105A stored in the RAM 13. When the random number information 105A does not match the random number information 105B, the multifunction machine 100 assumes that the authentication request is transmitted from a device that is not held over the NFC tag 101, and proceeds to S19 to notify the mobile terminal 200 that the authentication has failed.

When the CPU 11 determines that the random number information 105A matches the random number information 105B, that is, when the CPU 11 determines that the random number information 105 is valid, the CPU 11 determines that the authentication request is transmitted from a device held over the NFC tag 101, and proceeds to S17 to cause the authentication part 16 to execute an authentication process. In this case, the CPU 11 deletes the used random number information 105A from the RAM 13.

S18-S20 are steps illustrating the processing of the multifunction machine 100 in S1009-S1010 illustrated in FIG. 10. In S18, the authentication part 16 acquires the user information from the local authentication database 120 of the storage 17 and determines whether or not the authentication information 203 transmitted from the mobile terminal 200 matches the user information registered in the local authentication database 120. In this case, as described above, when the user information is registered with an external server, the authentication part 16 acquires the user information from the external server and then determines whether or not the authentication information 203 matches the user information. When the user information in the local authentication database 120 matches the authentication information 203, the mobile terminal 200 determines that the authentication is from an appropriate user, and performs login authentication. In S20, the multifunction machine 100 notifies the mobile terminal 200 via the Wi-Fi (registered trademark) wireless communication 400 that the authentication is successful. On the other hand, when the authentication information 203 does not match the user information in the local authentication database 120, in S19, the multifunction machine 100 notifies the mobile terminal 200 that the authentication has failed.

By the above processing, the multifunction machine 100 permits the user to use various functions and services.

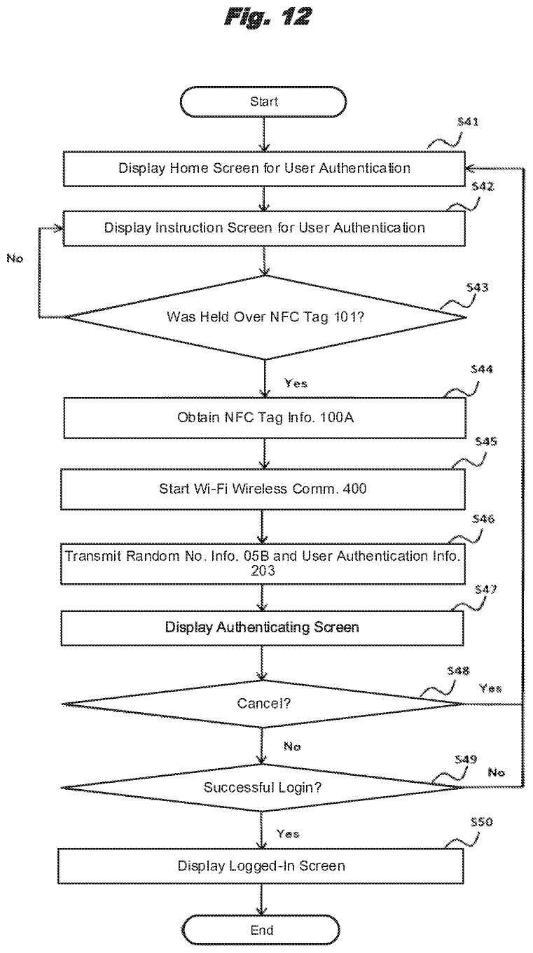

Next, FIG. 12 is a flow diagram illustrating an operation of the mobile terminal 200 in the present embodiment.

It is assumed that the authentication information 203 has been input on the authentication information input and display screen 260 in advance. The following steps illustrate an operation of the mobile terminal 200 in S1003 S1011 illustrated in FIG. 10.

In S41, when the dedicated application 20 is started by a user operation, the display control part 24 displays the home screen 250 illustrated in FIG. 8A on the touch panel 210. In S1002 illustrated in FIG. 10, when the user presses the login authentication button 251 in the state that the authentication information 203 has been input, the application control part 27 causes the display control part 24 to display the instruction screen 270 on the touch panel 210.

In S42, the display control part 24 displays the instruction screen 270 illustrated in FIG. 8C on the touch panel 210. Based on the instruction “Please hold over the device” displayed on instruction screen 270, the user holds the mobile terminal 200 over the NFC tag 101 (S1004 in FIG. 10).

In S43, when the mobile terminal 200 is held over the NFC tag 101, the mobile terminal 200 proceeds to S44. On the other hand, when the mobile terminal 200 is not held over the NFC tag 101, the instruction screen 270 is displayed on the touch panel 210.

In S44, when the mobile terminal 200 is held over the NFC tag 101, the NFC communication part 201 reads the NFC tag information 100A from the NFC tag 101 via the near field communication 300. Next, the NFC tag analysis part 203 analyzes the content of the acquired NFC tag information 100A and acquires the random number information 105B and the device information 106A. The application control part 27 temporarily stores the acquired random number information 105B in the RAM 2002.

In S45, based on the device information 106 read in S44, the application control part 27 starts the Wi-Fi (registered trademark) wireless communication 400 with the multifunction machine 100 via the wireless network IF 202.

In S46, the authentication information management part 26 passes the input authentication information 203 to the wireless network IF 202, and the application control part 27 transmits via the wireless network IF 202 the random number information 105B and the authentication information 203 read from the NFC tag 101 to the multifunction machine 100 as an authentication request.

In S47, the application control part 27 causes the display control part 24 to display the authenticating screen 280 on the touch panel 210.

In S48, when the user presses the cancel button 281 displayed on the authenticating screen 280, the application control part 27 causes the display control part 24 to display the home screen 250, and returns to S41. After that, the application control part 27 deletes the random number information 105B stored in the RAM 2002.

In S49, when an authentication result indicating a successful login is received from the multifunction machine 100 via the Wi-Fi (registered trademark) wireless communication 400, the application control part 27 proceeds to S50 to cause the display control part 24 to display the logged-in screen 290 on the touch panel 210. After that, the application control part 27 deletes the random number information 105B stored in the RAM 2002. Further, when an authentication result indicating a failed login is received, the application control part 27 returns to S41 to cause the display control part 24 to display the home screen 2501 on the touch panel 210. After that, the application control part 27 deletes the random number information 105B stored in the RAM 2002.

As a result of the above steps, the mobile terminal 200 can use the dedicated application 20 to use various services of the multifunction machine 100. For example, using an authentication print function, image data transmitted to the multifunction machine 100 in advance can be printed after authentication. The term “login” in the present embodiment refers to a remote login process.

According to the present embodiment, even for the mobile terminal 200 that cannot write to the NFC tag 101, by simply holding the mobile terminal 200 over the multifunction machine 100, login authentication using the NFC tag 101 can be performed. Further, since the multifunction machine 100 uses the randomly generated random number information 105, security is also high. Further, since the near field communication 300 is used to acquire the random number information 105, for example, the random number information 105 is less likely to be intercepted by others as compared to that in the case of login authentication using only the Wi-Fi (registered trademark) wireless communication 400. Therefore, highly secure login authentication (remote login) can be performed. Further, by setting a validity time period for the random number information 105, the security can be further improved.

The user name 2031 and the password 2032 are used as the authentication information 203 in the present embodiment. However, it is also possible that a terminal ID such as a MAC address of a mobile terminal is used as the authentication information 203. Further, in the present embodiment, the authentication information 203 and the random number information 105B transmitted from the mobile terminal 200 to the multifunction machine 100 correspond to a specific example of authentication request information in the present invention.

### Second Embodiment

Next, a second embodiment in the present invention is described.

In the first embodiment, the mobile terminal 200 transmits the random number information 105B acquired via the near field communication 300 and the authentication information 203 via the Wi-Fi (registered trademark) wireless communication 400, and the multifunction machine 100 determines whether or not the random number information 105A stored in the RAM 13 matches the random number information 105B transmitted from the mobile terminal 200.

The mobile terminal 200 in the second embodiment encrypts the authentication information 203 using the random number information 105B read from the NFC tag 101 as a common key, and transmits the encrypted authentication information 203 to the multifunction machine 100. Next, the multifunction machine 100 decrypts the received authentication information 203 using the random number information 105A stored in the RAM 13. Further, in post-login processes, the multifunction machine 100 and the mobile terminal 200 encrypt and decrypt various kinds of data (for example, print data and scan data) using the random number information 105 used for the login authentication as a common key.

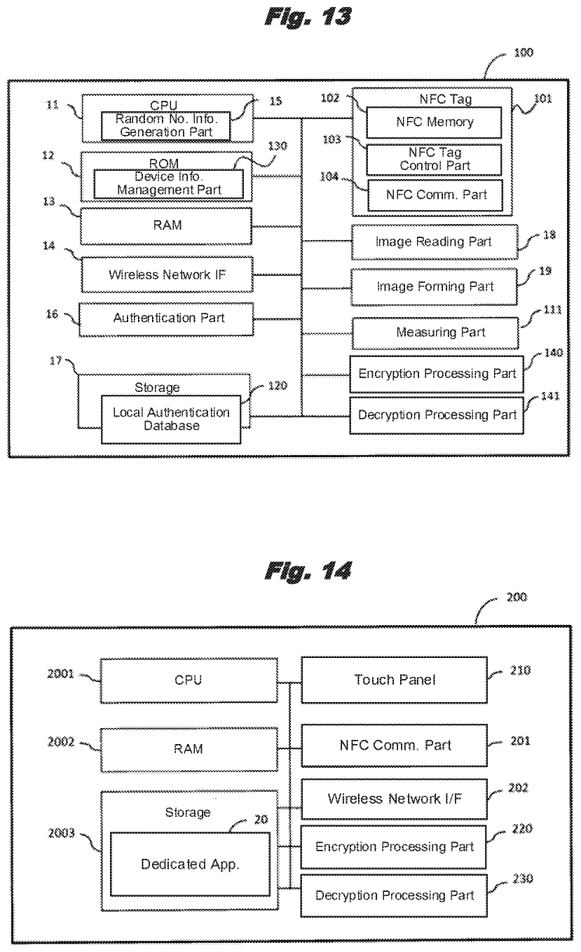

FIG. 13 illustrates a configuration of the multifunction machine 100 in the present embodiment.

The same components as those in the first embodiment are denoted using the same reference numeral symbols, and a description thereof is omitted.

The multifunction machine 100 of the present embodiment has an encryption processing part 140 and a decryption processing part 141.

The encryption processing part 140 uses the random number information 105 as a common key to encrypt a processing result obtained by executing a processing request from the mobile terminal 200.

The decryption processing part 141 uses the random number information 105A to decrypt the authentication information 203 encrypted by the mobile terminal 200 or a processing request encrypted by the mobile terminal 200.

FIG. 14 illustrates a configuration of the mobile terminal 200 in the present embodiment.

The same components as those in the first embodiment are denoted using the same reference numeral symbols, and a description thereof is omitted.

The multifunction machine 200 of the present embodiment has an encryption processing part 220 and a decryption processing part 230.

The encryption processing part 220 uses the random number information 105 as a common key to encrypt the authentication information 203 and various kinds of data.

The decryption processing part 230 uses the random number information 105A to decrypt a processing result encrypted by the multifunction machine 100.

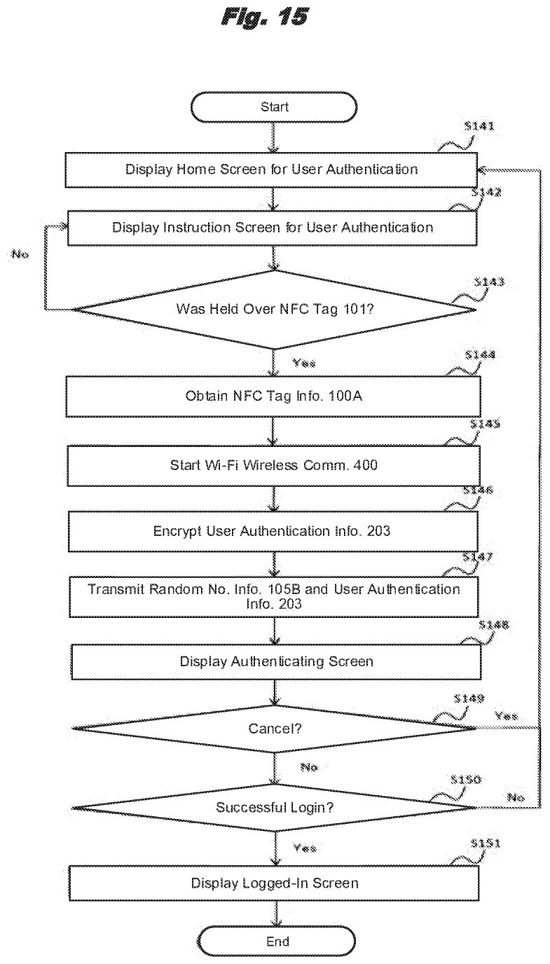

FIG. 15 is a flow diagram illustrating an operation of the mobile terminal 200 in the login authentication of the present embodiment.

In the first embodiment, the random number information 105B stored in RAM 2002 is deleted regardless of a successful or failed login. However, in the present embodiment, in the case of a successful login, the mobile terminal 200 continues to store the random number information 105B in the RAM 2002 without deleting the random number information 105B. Further, steps that are the same as those in the first embodiment are omitted as appropriate in the description.

In S146, the encryption processing part 230 encrypts the authentication information 203 using the random number information 105B read from the NFC tag 101 as a common key, and passes the encrypted authentication information 203 to the wireless network IF 202. In S147, the wireless network IF 202 transmits the encrypted authentication information 203 as authentication request information to the multifunction machine 100 via the Wi-Fi (registered trademark) wireless communication 400.

The subsequent steps are the same as those in the first embodiment.

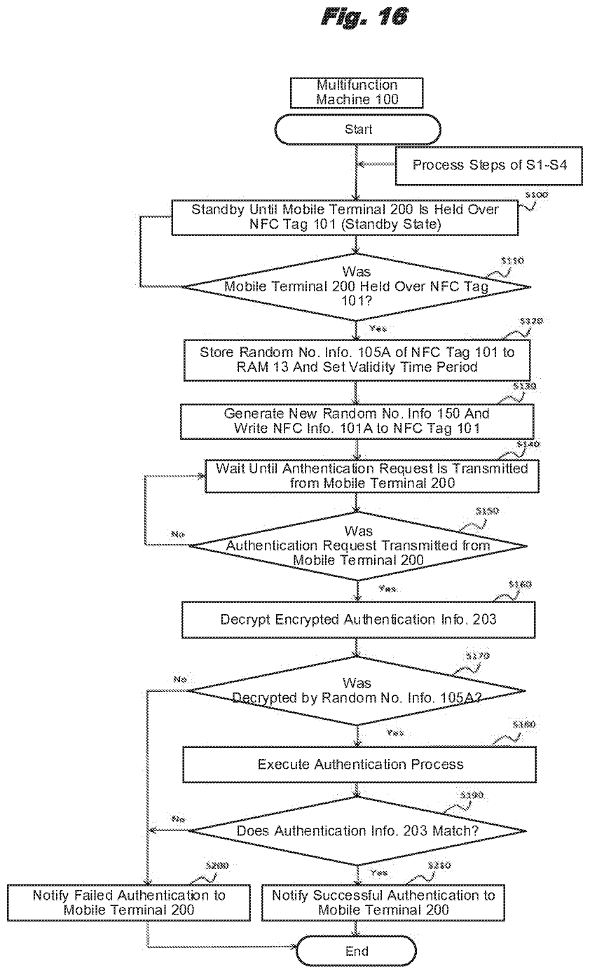

FIG. 16 is a flow diagram illustrating an operation of the multifunction machine 100 in the present embodiment.

In S17 of the first embodiment, the random number information 105A stored in RAM 13 was deleted. However, in the present embodiment, the multifunction machine 100 continues to store the random number information 105A in the RAM 13 without deleting the random number information 105A. Further, steps that are the same as those in the first embodiment are omitted as appropriate in the description.

In S160, the wireless network IF 14 receives the encrypted authentication information 203 from the mobile terminal 200 and passes the encrypted authentication information 203 to the decryption processing part 141. Next, the decryption processing part 141 uses the random number information 105A to decrypt the encrypted authentication information 203. In S170, the decryption processing part 141 passes a result indicating whether or not the decryption is successful to the CPU 11. After that, when the authentication information 203 can be decrypted using the random number information 105A by the decryption processing part 141, the CPU 11 further determines whether or not the validity time period 111X of the random number information 105A used for the decryption has passed. When the decryption using the random number information 105A is successful and the validity time period 111X has not passed, the CPU 11 determines that the authentication request is transmitted from a device held over the NFC tag 101, and proceeds to S180. When the authentication information 203 could not be decrypted using the random number information 105A or the validity time period 111X has passed, the CPU 11 determines that the authentication request is not transmitted from a device held over the NFC tag 101, and terminates the process. In S200, the CPU 11 causes the wireless network IF 14 to notify the mobile terminal 200 of the authentication result (failure) via the Wi-Fi (registered trademark) wireless communication 400. S180 and subsequent steps are the same as those in the first embodiment.

Further, in the second embodiment, in post-login processes, when using the dedicated application to transmit a print instruction, or an instruction for authentication printing or the like to the multifunction machine 100, the mobile terminal 200 encrypts various kinds of data using the random number information 105B and transmits the encrypted data. As a result, the multifunction machine 100 performs decryption using the random number information 105A stored in the RAM 13, and thereby, can determine whether or not various kinds of data are transmitted from a device held over the NFC tag 101.

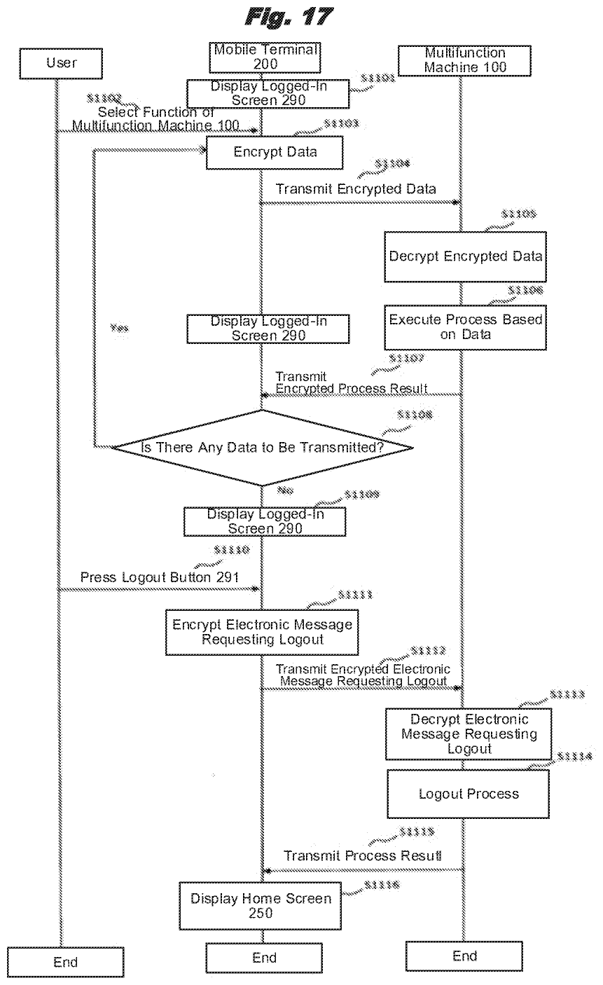

FIG. 17 is a flow diagram after a login process in the present embodiment.

In S1101, the mobile terminal 200 displays the logged-in screen 290 illustrated in FIG. 8E on the touch panel 210. In S1102, the user selects functions of the multifunction machine 100 that are displayed. Further, in the flow diagram, encryption and decryption of data in the mobile terminal 200 are respectively performed by the encryption processing part 220 and the decryption processing part 230. Encryption and decryption of data in the multifunction machine 100 are respectively performed by the encryption processing part 140 and the decryption processing part 141.

In S1103, the mobile terminal 200 encrypts data (electronic message) corresponding to a function selected by the user. In S1104, the mobile terminal 200 performs transmission to the multifunction machine 100 via the Wi-Fi (registered trademark) wireless communication 400. For example, in S1102, when the function is “display an authentication job list” on the logged-in screen 290, the mobile terminal 200 encrypts the data and transmits the encrypted data to the multifunction machine 100. When the function is “print image data,” the mobile terminal 200 encrypts image data desired by the user and transmits the encrypted image data to the multifunction machine 100.

In S1105, the multifunction machine 100 decrypts encrypted data using the random number information 105A. In S1106, the multifunction machine 100 executes a process based on the decrypted data. In S1107, the multifunction machine 200 encrypts a processing result using the random number information 105A and transmits encrypted processing result to the mobile terminal 200 via the Wi-Fi (registered trademark) wireless communication 400. Here, the term “processing result” means that when data transmitted from the mobile terminal 200 is “display an authentication job list” in S1104, an authentication job list of the user based on the authentication information 203 is transmitted to the mobile terminal 200. Further, in the case of “print image data,” an image forming part 1006 may perform printing based on the data.

In S1108, the mobile terminal 200 decrypts the processing result encrypted in S1107. After that, the processing result is displayed on touch panel 210. For example, when an “authentication job list” is received as the processing result, the “authentication job list” is displayed on the touch panel 210. When there is other data to be transmitted, for example, when there is other selected image data or data based on a job selected by the user from an authentication job list, the process returns to S1103. When there is no other data to be transmitted, the mobile terminal 200 proceeds to S1109 to display a logged-in screen 290 on the touch panel 210, and waits for the next operation. The mobile terminal 200 repeats S1101-S1109 until the user presses the logout button 291.

When the user presses the logout button 291 in S1110, the mobile terminal 200 causes the encryption processing part 220 to use the random number information 105B as a common key to encrypt an electronic message requesting logout in S1111, and transmits the encrypted electronic message to the multifunction machine 100 via the Wi-Fi (registered trademark) wireless communication 400 in S1112. After that, the mobile terminal 200 deletes the random number information 105B stored in the RAM 2002. As a result, logout due to proofing can be prevented.

In S1113, the multifunction machine 100 causes the decryption processing part 141 to use the random number information 105A to decrypt the electronic message requesting logout received from the mobile terminal 200. After that, the multifunction machine 100 performs a logout process in S1114, and transmits a processing result indicating completion of logout to the mobile terminal 200 via the Wi-Fi (registered trademark) wireless communication 400 in S1115. After that, the multifunction machine 100 deletes the random number information 105A stored in the RAM 13. In S1116, when the processing result of S1115 is received, the mobile terminal 200 displays the home screen 250 on the touch panel 210.

Further, in addition to the above-described logout process caused by pressing the logout button 291, the logout process may also be the following.

A logout process caused by a user operation from the operation panel 110 of the multifunction machine 100 and a logout process caused by a timeout when the mobile terminal 200 and the multifunction machine 100 have not been operated for a certain period are also possible. For the logout process of the operation panel 110, when a user performs an operation to logout, the authentication part 16 executes the logout process.

Further, for the logout process due to a certain time period of inactivity, for example, when no data is received for a certain time period via the dedicated application 20 from the mobile terminal 200 which has logged in, the logout process due to a timeout is performed. That is, when a time period of inactivity exceeding a preset time period is measured by the measuring part 111, the authentication part 16 executes the logout process.

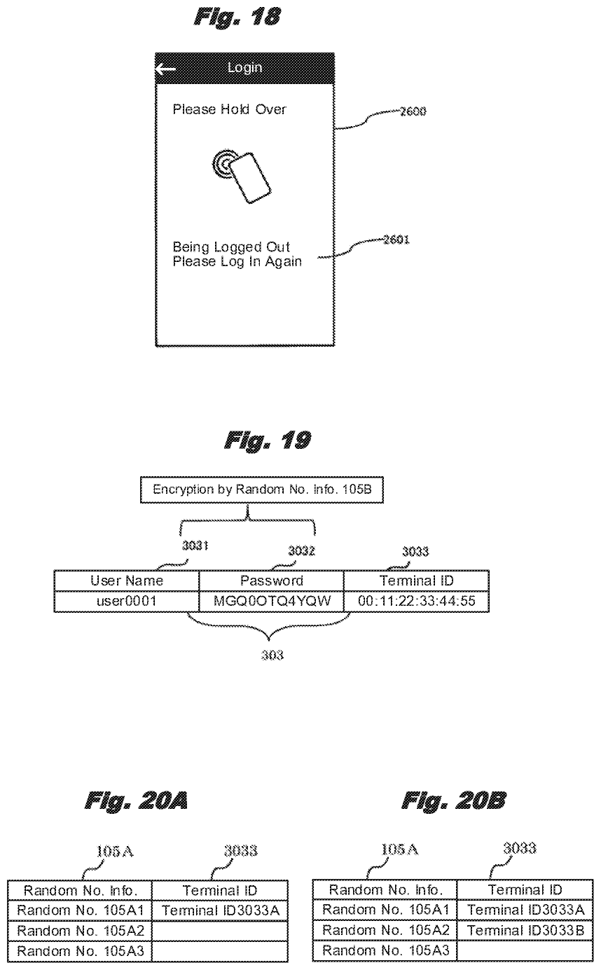

FIG. 18 illustrates a logout notification screen 2600 in the second embodiment.

When the logout process due to the operation panel 110 or the logout process due to a timeout as described above is performed, the mobile terminal 200 deletes the random number information 105B from the RAM 2002 in any one of the following cases.

A notification indicating that decryption has failed is received from the multifunction machine 100. That is, when various kinds of encrypted data cannot be decrypted due to the deletion of the random number information 105A after the logout process, the multifunction machine 100 notifies the mobile terminal 200 to that effect. As a result, the mobile terminal 200 deletes the random number information 105B stored in the RAM 2002. Further, a logout notification screen 2600 is displayed on the touch panel 110. In this case, a message 2601 indicating the logout is displayed on the logout notification screen 2600 to allow the user to know that the user has been logged out by the multifunction machine 100.

According to the above configuration, by encrypting the authentication information 203 using the random number information 105 as a common key, even when the authentication information 203 is intercepted by others, the authentication information 203 cannot be deciphered. Further, also in post-login processes, by encrypting various kinds of data using the random number information 105 as a common key, interception of the various kinds of data or proofing can be prevented, and an even more highly secure information processing system can be constructed. Further, the encrypted authentication information 203 corresponds to a specific example of the authentication request information of the present invention.

### Third Embodiment

Next, a third embodiment is described. The third embodiment is an embodiment for a case where multiple users (mobile terminals 200) interact with the multifunction machine 100. For example, in user authentication on the machine side for mobile terminals using NFC, when it is possible to operate the multifunction machine 200 from multiple mobile terminals 200 (remote login), not only a single mobile terminal (user) but multiple terminals are authenticated, and it is necessary to have a mechanism for performing communication after identifying a terminal from which information is transmitted.

FIG. 19 illustrates authentication information 303 of the present embodiment. In the first embodiment and the second embodiment, the user name 2031 and the password 2032 are used as the authentication information. In the present embodiment, a terminal ID is further included in the authentication information.

Regarding authentication information 303, since some components, which are except for the terminal ID, have configurations that are the same as those of the first embodiment and the second embodiment, a description thereof is omitted.

As illustrated in FIG. 19, the configuration of the authentication information 303 is different from that of the first embodiment and the second embodiment in that, in addition to a user name 3031 and a password 3032, a terminal ID 3033 is included. Further, the user name 3031 and the password 3032 are encrypted using the random number information 105 as a common key, and the authentication information 303 with the terminal ID 3033 added is transmitted to the device side. The terminal ID 3033 is a MAC address or the like that uniquely identifies for the mobile terminal 200.

In the multifunction machine 100, the CPU 11 uses the random number information 105A to decrypt the authentication information 303 transmitted from the mobile terminal 200, and stores the random number information 105A in association with the terminal ID 3033 in the decrypted authentication information 303. That is, a result obtained by adding the terminal ID 3033 to the encrypted user name 3031 and password 3032 is transmitted to the multifunction machine 100 as the authentication information 303.

Here, the authentication information 303 corresponds to a specific example of the authentication request information of the present invention.

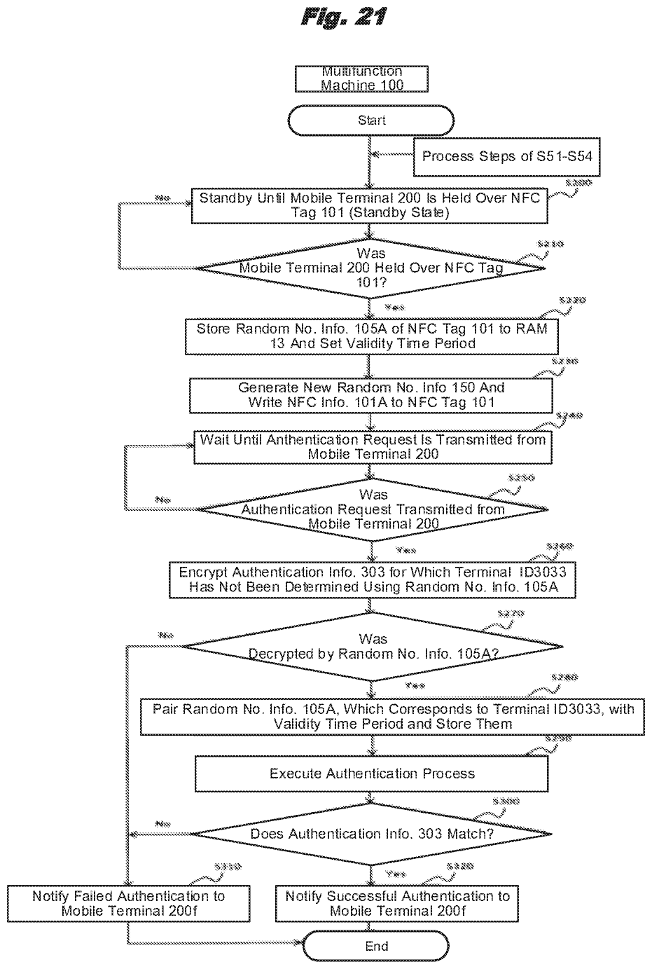

FIGS. 20A and 20B are each schematic diagram illustrating a state in which the random number information 105A and the terminal ID 3033 stored in the multifunction machine 100 in the present embodiment are associated with each other. FIG. 21 is a flow diagram illustrating an operation of the multifunction machine 100 in the present embodiment.

Processing of S200-S250 has been described in the first embodiment and the second embodiment, and thus, a description thereof is omitted. However, it is assumed that multiple users (mobile terminals 200) have read the random number information 105 from the NFC tag 101. In S260, decryption is performed using a random number information 105A for which a terminal ID 3033 has not been determined among multiple random number informations 105A stored in the RAM 13. That is, decryption is performed using a random number information 105A that has not been associated with a terminal ID 3033, and a random number information 105A that allows the decryption to be correctly performed is determined. For example, when authentication information 303A can be decrypted using random number information 105A1, next, it is determined whether or not the validity time period 111X has passed, and when the validity time period 111X has not passed, as illustrated in FIG. 20A, the random number information 105A1 and the terminal ID 3033A are paired and are stored in the RAM 13.

After that, using FIG. 20B, a case is described where an authentication request based on authentication information (not illustrated in the drawings), which is different from the authentication information 303, and random number information 105A2 is transmitted from a different user (mobile terminal). The random number information 105A1 is associated with the terminal ID 3033A. However, when a terminal ID 3033 has not been determined for each of other random number informations 105A (for example, random number information 105A2 and random number information 105A3), a process is performed to determine whether or not authentication information different from the authentication information 303 can be decrypted using the random number information 105A2 or the random number information 105A3. That is, decryption is performed using a round-robin method using the random number informations 105A for each of which a terminal ID 3033 has not been determined. After that, when the authentication information different from the authentication information 303 can be decrypted using the random number information 105A2, the random number information 105A2 and a terminal ID 3033B from the authentication information are paired and are stored in the RAM 13.

Further, the random number information 105A and the terminal ID 3033 are paired and stored in S280 after S270. However, it is also possible that the above operation is performed after the authentication process is completed (successful authentication).

The subsequent steps are the same as those in the first embodiment and the second embodiment.

After the authentication by the above steps, in order to decrypt data (such as authentication print data or image data to be normally printed) encrypted using a random number, the multifunction machine 100 stores the random number information 105A corresponding to the terminal ID 3033 determined in the above steps in the RAM 13, and further, the mobile terminal 200 adds the terminal ID 3033 to the encrypted data and transmits the encrypted data with the terminal ID 3033 to multifunction machine 100. Thereby, the multifunction machine 100 can identify the random number information 105A corresponding to the terminal ID 3033 from the multiple random number informations 105A stored in the RAM 13. That is, it is not necessary to decrypt received data using all the random number informations stored in the RAM 13. By decrypting the received data using the random number information 105A stored in association with the terminal ID 3033, a processing request from the mobile terminal 200 can be immediately identified.

According to the above configuration, a system that can be accessed by multiple users by remote login or the like can be realized. In this case, in the communication from the terminal, a mechanism is realized that allows communication to be performed by performing decryption using one random number associated with the authentication information without performing decryption using all the random number informations during the authentication. Thereby, a processing time period can be shortened.

### OTHER EMBODIMENTS

In the second embodiment and the third embodiment, data encrypted by the mobile terminal 200 is decrypted by the multifunction machine 100. However, without being limited to this, it is also possible that data processed by the multifunction machine 100 (for example, a job list of authentication printing, scan data, or the like) is encrypted by the multifunction machine 100 and the encrypted data is transmitted to the mobile terminal 200 via the Wi-Fi (registered trademark) wireless communication 400, and the encrypted data is decrypted on the mobile terminal 200 side using the random number information. Further, in the present invention, the multifunction machine 100 is described as an information processing apparatus. However, without being limited to this, a facsimile machine, a printer, and the like may also be used.

Further, the present invention is not limited to the above embodiments. Based on the spirit of the present invention, various modifications are possible, which are not to be excluded from the scope of the present invention.

What is claimed is:

1. An authentication method, comprising:
a step in which an information processing apparatus acquires user information;
a step in which the information processing apparatus writes first identification information to an NFC tag;
a step in which the mobile terminal acquires, via Near Field Communication (hereinafter as NFC), the first identification information written to the NFC tag and stores the acquired first identification information as acquired information;
a step in which, after the mobile terminal acquired the first identification information, the information processing apparatus stores the first identification information and sets a validity time period for the first identification information;
a step in which the mobile terminal transmits authentication request information corresponding to authentication information and the acquired information to the information processing apparatus via long distance wireless communication which is different from the NFC;
a step in which the information processing apparatus determines whether or not the authentication request information is received from the mobile terminal before the validity time period of the first identification information has passed; and
a step in which, when the authentication request information is received from the mobile terminal within the validity time period, the information processing apparatus performs an authentication process based on the user information, the first identification information, and the authentication request information.

2. The authentication method according to claim 1, further comprising:
a step in which, after the mobile terminal acquired the first identification information from the NFC tag, the information processing apparatus writes second identification information that is different from the first identification information to the NFC tag.

3. The authentication method according to claim 1, comprising:
a step in which the information processing apparatus determines whether or not the first identification information received from the mobile terminal matches the first identification information stored in the information processing apparatus;
a step in which, when the first identification information received from the mobile terminal matches the first identification information stored in the information processing apparatus, the information processing apparatus performs an authentication process based on the user information and the authentication information, and
a step in which, when the first identification information received from the mobile terminal does not match the first identification information stored in the information processing apparatus, the information processing apparatus does not performs the authentication process.

4. The authentication method according to claim 1 further comprising:
a step in which the mobile terminal encrypts the authentication information using the acquired information, and transmits the encrypted authentication information as the authentication request information to the information processing apparatus; and
a step in which the information processing apparatus decrypts the encrypted authentication information using the first identification information.

5. The authentication method according to claim 4, wherein
the authentication request information further includes the encrypted authentication information and terminal information,
the authentication method further comprising a step in which, when the encrypted authentication information was decrypted by using the first identification information, the information processing apparatus stores the first identification information and the terminal information in association with each other.

6. The authentication method according to claim 1, wherein
the information processing apparatus further comprises a random number information generation part that is configured to generate random numbers, and
the first identification information and the second identification information are formed with random numbers by the random number information generation part.

7. An authentication processing system, comprising:
an information processing apparatus; and
a mobile terminal, wherein
the information processing apparatus includes:
a first control part that writes first identification information to an NFC tag, and, after the mobile terminal acquired the first identification information, sets a validity time period for the first identification information;
a first wireless communication part that performs Near Field Communication (hereinafter as NFC) with the mobile terminal;
a second wireless communication part that performs long distance wireless communication with the mobile terminal;
an identification information storage part that stores the first identification information acquired by the mobile terminal; and
an authentication part that acquires user information and performs an authentication process based on the user information,
the mobile terminal includes:
an input part that inputs authentication information corresponding to the user information;
a third wireless communication par that acquires via NFC the first identification information stored by the NFC tag as acquired information;
a fourth wireless communication part that transmits authentication request information corresponding to the acquired information and the authentication information to the information processing apparatus via long distance wireless communication; and
a second control part that causes the fourth wireless communication part to transmit the authentication request information corresponding to the acquired information and the authentication information to the information processing apparatus via the long distance wireless communication,
the first control part determines whether or not the authentication request information is received from the mobile terminal via the long distance wireless communication within the validity time period of the first identification information, and, when the authentication request information was received from the mobile terminal within the validity time period, causes the authentication part to perform the authentication process based on the user information and the first identification information, and the authentication request information received from the mobile terminal.

8. The authentication processing system according to claim 7, wherein
after the mobile terminal acquired the first identification information, the first control part generates second identification information different from the first identification information, and writes the generated second identification information to the NFC tag.

9. The authentication processing system according to claim 7, wherein
the second control part causes the fourth wireless communication part to transmit the first identification information and the authentication information as the authentication request information, and
the first control part determines whether or not the first identification information received from the mobile terminal matches the first identification information stored in the identification information storage part, and,
when the first identification information received from the mobile terminal matches the first identification information stored in the identification information storage part, performs an authentication process based on the user information and the authentication information, and
when the first identification information received from the mobile terminal does not match the first identification information stored in the identification information storage part, does not perform the authentication process.

10. The authentication processing system according to claim 9, wherein
the authentication request information further includes the encrypted authentication information and terminal information, and,
when the encrypted authentication information was decrypted by using the first identification information, the first control part stores the first identification information and the terminal information in association with each other in the identification information storage part.

11. The authentication processing system according to claim 7, wherein
the information processing apparatus further comprises a random number information generation part that is configured to generate random numbers, and
the first identification information and the second identification information are formed with random numbers by the random number information generation part.

12. An information processing apparatus capable of communicating with a mobile terminal, the information processing apparatus, comprising:
a first control part that writes first identification information to an NFC tag, and, after the mobile terminal acquires the first identification information, sets a validity time period for the first identification information;
a near field communication part that performs Near Field Communication (hereinafter as NFC) with the mobile terminal;
a long distance wireless communication part that performs long distance wireless communication with the mobile terminal;
an identification information storage part that stores the first identification information acquired by the mobile terminal; and
an authentication part that acquires user information and performs an authentication process based on the user information, wherein
the first control part determines whether or not the authentication request information is received from the mobile terminal via the long distance wireless communication within the validity time period of the first identification information, and, when the authentication request information was received from the mobile terminal within the validity time period, causes the authentication part to perform the authentication process based on the user information and the first identification information, and the authentication request information received from the mobile terminal.

13. The information processing apparatus according to claim 12, further comprising:
a random number information generation part that is configured to generate random numbers, wherein
the first identification information and the second identification information are formed with random numbers by the random number information generation part.
